(19) United States
(12) Patent Application Publication
(10) Pub. No.: US 2025/0089025 A1
(43) Pub. Date: Mar. 13, 2025

(54) WIRELESS COMMUNICATION METHOD AND APPARATUS

(71) Applicant: LENOVO (BEIJING) LIMITED, BEIJING (CN)

(72) Inventors: HONGMEI LIU, BEIJING (CN); ZHI YAN, BEIJING (CN); YUANTAO ZHANG, BEIJING (CN); YINGYING LI, BEIJING (CN); HAIMING WANG, BEIJING (CN)

(21) Appl. No.: 18/722,419

(22) PCT Filed: Dec. 20, 2021
(86) PCT No.: PCT/CN2021/139741

§ 371 Date: Jun. 20, 2024

(51) Int. Cl. H04W 72/0446; H04B 7/06; H04B 17/309

(52) U.S. Cl. CPC H04W 72/0446; H04B 7/0626; H04B 7/0695; H04B 17/347

(57) ABSTRACT

Embodiments of the present application are related to a wireless communication method and apparatus. According an embodiment of the present application, an exemplary method includes: receiving a signaling indicating a first set of reference signal (RS), wherein a spatial domain filter associated with the first set of RS is on or off; and determining a second set of RS based on the signaling, wherein the second set of RS is a set of RS associated with channel state information (CSI) reporting, or a set of pathloss RS, or a set of RS associated with radio link monitoring (RLM), or a set of RS associated with beam failure recovery (BFR).

### TECHNICAL FIELD

Embodiments of the present application generally relate to wireless communication technologies, especially to a wireless communication method and apparatus for data transmission.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

To improve network energy savings in terms of both base station (BS) transmission and reception, techniques are studied and identified on the BS side and user equipment (UE) side. For example, according to RP-212669, the focus areas include how to achieve more efficient dynamic and/or semi-static and finer granularity adaptation of transmissions and/or receptions in one or more of time, frequency, spatial, and power domains, with potential support/feedback from UE. Additional areas of the study may include UE assistance information and intra-network information exchange/coordination. In addition, RP-212669 also provides that legacy UEs should be able to continue accessing a network implementing Rel-14 network energy savings techniques, with the possible exception of techniques developed specifically for greenfield deployments.

Thus, it is desirable to improve technical solutions for data transmission, especially considering saving energy in BS side and UE side as required to adapt to the industry trend.

### SUMMARY OF THE DISCLOSURE

One objective of the present application is to provide a wireless transmission method and apparatus, which can at least save energy in the BS side and UE side.

According to some embodiments of the present application, a remote apparatus includes: at least one receiving circuitry; at least one transmitting circuitry; and at least one processor coupled to the at least one receiving circuitry and the at least one transmitting circuitry. The at least one processor is configured to: receive, via the at least one receiving circuitry, a signaling indicating a first set of reference signal (RS), wherein a spatial domain filter associated with the first set of RS is on or off; and determine a second set of RS based on the signaling, wherein the second set of RS is a set of RS associated with channel state information (CSI) reporting, or a set of pathloss RS, or a set of RS associated with radio link monitoring (RLM), or a set of RS associated with beam failure recovery (BFR).

In some embodiments of the present application, in the case that the second set of RS is a set of RS associated with CSI reporting to be received for CSI measurement, and the spatial domain filter associated with at least one RS of the second set of RS is off, the at least one processor is configured to: exclude the at least one RS from the second set of RS.

In some embodiments of the present application, in the case that the second set of RS is a set of RS associated with CSI reporting to be measured, and the spatial domain filter associated with at least one RS of the second set of RS is off, the at least one processor is configured to: exclude the at least one RS from the second set of RS.

In some embodiments of the present application, in the case that the second set of RS is a set of RS associated with CSI reporting where CSI measurement will be averaged, and the spatial domain filter associated with at least one RS of the second set of RS is off, the at least one processor is configured to: exclude the at least one RS from the second set of RS. Averaging CSI measurement on the second set of RS before application of the signaling is separate from averaging CSI measurement on the second set of RS after application of the signaling according to some embodiments of the present application.

In some embodiments of the present application, in the case that the second set of RS is a set of RS associated with CSI reporting where at least one resource index will be reported, and the spatial domain filter associated with at least one RS of the second set of RS is off, the at least one processor is configured to: exclude the at least one RS index from a set of RS index for CSI reporting; or exclude the at least one RS from the second set of RS. The set of RS index for CSI reporting is a single RS index or a pair of RS indexes.

In some embodiments of the present application, in the case that the second set of RS is a set of RS associated with CSI reporting where CSI will be based on a CSI resource, and the spatial domain filter associated with the CSI resource is off, the at least one processor is configured to: stop reporting the CSI; or report the CSI with a reserved or predefined value.

In some embodiments of the present application, in the case that the second set of RS is a set of pathloss RS for power control of at least one of physical uplink shared channel (PUSCH), physical uplink control channel (PUCCH) or sounding reference signal (SRS) or for power headroom reporting, and the spatial domain filter associated with at least one RS of the second set of RS is off, the at least one processor is configured to: exclude the at least one RS from the second set of RS.

In some embodiments of the present application, in the case that the second set of RS is a set of pathloss RS for power control of at least one of PUSCH, PUCCH or SRS or for power headroom reporting, and the spatial domain filter associated with at least one RS of the second set of RS is on, the at least one processor is configured to: add the at least one RS to the second set of RS in response to a total number of the second set of RS being less than a configured or predefined number. For example, the at least one RS is added to the second set of RS in an ascending order of RS index.

In some embodiments of the present application, in the case that the second set of RS is a pathloss RS for power control of at least one of PUSCH, PUCCH or SRS or for power headroom reporting, the pathloss RS is determined based on a lowest indexed PUCCH resource of a set of PUCCH resource, and the spatial domain filter associated with at least one RS of the set of PUCCH resource is off, the at least one processor is configured to: exclude the at least one RS from the set of PUCCH resource.

In some embodiments of the present application, in the case that the second set of RS is a RS associated with power control of at least one of PUSCH, PUCCH or SRS or associated with power headroom reporting, the pathloss RS is determined based on a lowest indexed control resource set (CORESET) of a set of CORESET, and the spatial domain filter associated with at least one CORESET of the set of CORESET is off, the at least one processor is configured to: exclude the at least one CORESET from the set of CORESET.

In some embodiments of the present application, in the case that the second set of RS is a pathloss RS for power control of at least one of PUSCH, PUCCH or SRS or for power headroom reporting, and the pathloss RS is based on a physical downlink shared channel (PDSCH) transmission configuration indication (TCI) state with lowest index of a set of PDSCH TCI state, and the spatial domain filter associated with at least one RS associated with at least one PDSCH TCI state of the set of PDSCH TCI state is off, the at least one processor is configured to: exclude the at least one PDSCH TCI state from the set of PDSCH TCI state.

In some embodiments of the present application, in the case that the second set of RS is a set of RLM RS, and the spatial domain filter associated with at least one RS of the second set of RS is off, the at least one processor is configured to: exclude the at least one RS from the second set of RS.

In some embodiments of the present application, in the case that the second set of RS is a set of RLM RS, and the spatial domain filter associated with at least one RS of the second set of RS is on, the at least one processor is configured to: add the at least one RS to the second set of RS.

In some embodiments of the present application, in the case that the second set of RS is a RLM RS determined based on a CORESET of a set of CORESET, and the spatial domain filter associated with at least one RS associated with at least one CORESET of the set of CORESET is off, the at least one processor is configured to: exclude the at least one CORESET from the set of CORESET.

In some embodiments of the present application, in the case that the second set of RS is a RLM RS determined based on a CORESET of a set of CORESET, and the spatial domain filter associated with at least one RS associated with at least one CORESET of the set of CORESET is on, the at least one processor is configured to: add the at least one CORESET to the set of CORESET.

In some embodiments of the present application, in the case that the second set of RS is a set of RS associated with BFR, and the spatial domain filter associated with at least one RS of the second set of RS is off, the at least one processor is configured to: exclude the at least one RS from the second set of RS. The set of RS associated with BFR is a set of candidate beam RS or a set of failure detection resource.

According to some other embodiments of the present application, a network apparatus includes: at least one receiving circuitry; at least one transmitting circuitry; and at least one processor coupled to the at least one receiving circuitry and the at least one transmitting circuitry. The at least one processor is configured to: transmit, via the at least one transmitting circuitry, a signaling indicating a first set of RS, wherein a spatial domain filter associated with the first set of RS is on or off; and determine a second set of RS based on the signaling, wherein the second set of RS is a set of RS associated with CSI reporting, or a set of pathloss RS, or a set of RS associated with RLM, or a set of RS associated with BFR.

In some embodiments of the present application, in the case that the second set of RS is a set of RS associated with CSI reporting where CSI will be based on a CSI resource, and the spatial domain filter associated with the CSI resource is off, the at least one processor is configured to: stop receiving the CSI; or receive the CSI with a reserved or predefined value.

Some other embodiments of the present application also provide a method, which includes: receiving a signaling indicating a first set of RS, wherein a spatial domain filter associated with the first set of RS is on or off; and determining a second set of RS based on the signaling, wherein the second set of RS is a set of RS associated with CSI reporting, or a set of pathloss RS, or a set of RS associated with RLM, or a set of RS associated with BFR.

Given the above, embodiments of the present application provide a technical solution supporting dynamic beam on/off indication to save network energy, obviate the impact on various physical layer procedures caused by the dynamic beam on/off indication, including random access channel (RACH), CSI measurement and reporting, BFR, RLM, radio resource management (RRM) etc., and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary wireless communication method according to some embodiments of the present application.

FIG. 3 illustrates a block diagram of an exemplary wireless communication apparatus according to some embodiments of the present application.

FIG. 4 illustrates a block diagram of an exemplary wireless communication apparatus according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems, and moreover, the terminologies recited in the present application may change, which should not affect the principle of the present application.

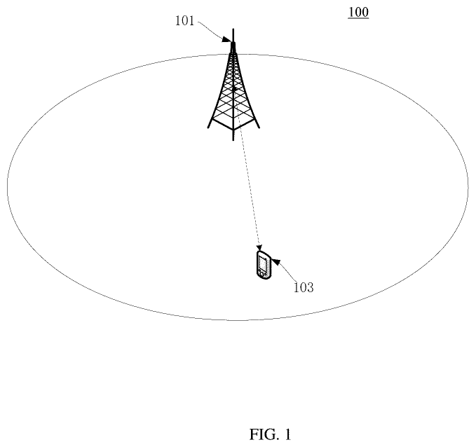

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 101 may transmit resource configuration information to the UE 103. A RS may be a CSI RS, an SSB, or an SRS etc., various RSs. In addition, a RS may be associated with a time domain filter, a frequency domain filter, or a spatial domain filter. Each beam (which may be represented by spatial relation information) of a BS or UE is associated with a spatial domain transmission or reception filter, which is associated with at least one RS. That is, each beam is also associated with at least one RS. From the perspective of the remote side, a downlink (DL) beam may be associated with a spatial domain reception filter, and an uplink (UL) beam may be associated with a spatial domain transmission filter. From the perspective of the network side, a DL beam may be associated with a spatial domain transmission filter, and a UL beam may be associated with a spatial domain reception filter. Thus, a beam being on or off can also be represented by a spatial domain filter being on or off.

In legacy technologies, e.g., NR R15 and R16, beam on/off is semi-statically indicated to the remote side (e.g., the UE side). For example, SSB indication is transmitted in system information block (SIB)1 or radio resource control (RRC) signaling. However, such a beam indication mechanism cannot well meet the energy saving requirement, which is an important item being studied and identified by 3GPP, specifically for greenfield deployments in the future.

Dynamically indicating beam on or off (also, referring to as “dynamic beam on/off indication mechanism” or “dynamic beam on/off indication”) can at least save energy in BS side and UE side. However, dynamic beam on/off indication mechanism will affect various physical layer procedures, e.g., candidate beam maintenance for BFR, pathloss RS maintenance for power control, CSI reference resource determination, CSI reporting content, RLM RS maintenance. Thus, to well implement the dynamic beam on/off indication mechanism in the wireless communication, all these impacts should be obviated.

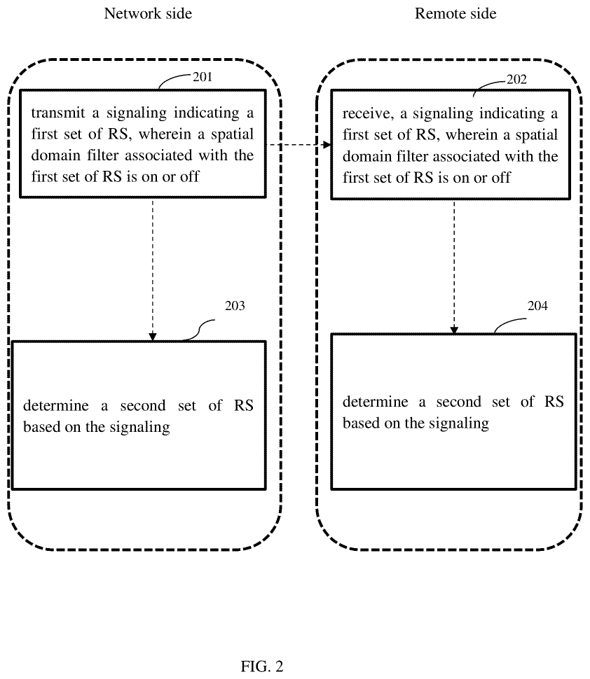

FIG. 2 is a flow chart illustrating an exemplary wireless communication method according to some embodiments of the present application. Although the method is illustrated in a system level by a remote apparatus in the remote side (e.g., the UE 103 as illustrated and shown in FIG. 1) and a network apparatus in the network side (e.g., the BS 101 as illustrated and shown in FIG. 1), persons skilled in the art should understand that the method implemented in the remote side and that implemented in the network side can be separately implemented and/or incorporated by other apparatus with the like functions.

According to embodiments of the present application, the network side, e.g., a gNB may dynamically indicate the remote side one or more beams on or off, which can at least save network energy. For example, as shown in FIG. 2, in step 201, the network side, e.g., a gNB, may transmit a signaling to the remote side, e.g., a UE, indicating a first set of RS, wherein a spatial domain filter (i.e., beam) associated with the first set of RS is indicated on or off. Herein, wording like “first” is only used for clear expression, and should not be deemed as the sequence limitation, and the wording “a/the set of” or the like means “one or more” or “at least one.” The signaling may also be referred to as “a beam on/off indication signaling,” or “a beam status indication signaling”, etc. Consistently, in step 202, the signaling will be received in the remote side (not considering data loss etc., factors). Persons skilled in the art should well know, the signaling for beam on/off indication may indicate the on/off status of more than one spatial domain filter, e.g., indicating a set of RS associated with a first domain filter being off, indicating another set of RS associated with a second domain filter being on, etc. In the case that the signaling indicates other spatial domain filter(s), the same or the like solution illustrated herein can be applied to other spatial domain filter(s) indicated by the signaling.

The first set of RS may be synchronization signal block (SSB), CSI-RS, or SRS, etc. The signaling may indicate the first set of RS by indicating the index of each RS. For example, an exemplary signaling may indicate SSB #1, SSB #3 and SRS resource #2 associated with a spatial domain filter indicated off.

The signaling can be various dynamic signaling. For example, in some embodiments of the present application, the signaling is media access control (MAC) control element (CE), scheduling downlink control information (DCI), or group common DCI. In some other embodiments of the present application, the signaling may be a UE specific DCI.

The signaling is associated with a time domain duration beginning from a time instance, which indicates when the UE will start to perform data transmission based on the first signaling and how long the first signaling is supposed to be applicable for the UE. As stated above, the data transmission should be understood in a broad sense, such as including control transmission, or RS transmission, etc., and hereafter considered the same. The time instance can be determined based on a predefined rule or is configured by a higher layer (e.g., layer higher than physical layer) signaling, e.g., RRC signaling or MAC CE. The time instance is determined based on a configured or predefined time domain delay between reception of the first signaling and application of the first signaling in the remote apparatus. In some other embodiments of the present application, in the case of the first signaling being group common DCI, the time instance may be determined as a slot boundary associated with the group common DCI based on a predefined rule, e.g., the starting boundary or the ending boundary of the group common DCI transmission slot or the group common DCI reception slot in the UE side. Regarding the time domain duration, it is configured by RRC or MAC CE, etc., higher layer signaling. The time domain duration is in a unit of millisecond, or in a unit of slot or other units. In the case that the unit is slot, a length of the slot is determined by configured subcarrier spacing (SCS), or by SCS determined implicitly. For example, the SCS can be based on frequency band. In an alternative example, the SCS can be the same as the group common DCI carrying the first signaling. In another alternative example, the SCS can be the same as the SCS associated with other group common DCI, e.g., DCI 2-0 or DCI 2-5.

According to some embodiments of the present application, the time domain duration is further divided into a plurality of sub-durations, and different sub-durations are associated with different RSs whose associated spatial domain filter is being set on or set off. In other words, different sub-durations are associated with different spatial domain filters being set on. For example, the signaling indicates beam on/off for 100 ms by indicating a pattern, and the 100 ms are divided into 10 sub-durations, each with 10 ms. Specifically, 0-9 ms is associated with beam status (i.e., on or off) indication #0, 10-19 ms is associated with beam status indication #1, . . . 90-99 ms is associated with beam status indication #9. Moreover, according to the signaling, for beam status #0, the beams associated with SSB #1, SSB #3 and SRS resource #2 is on; for beams status #1, the beams associated with CSI-RS resource #2 and CSI-RS resource index #5 is on; . . . and for beam status #9, the beam associated with SSB #2, CSI-RS resource index #2, CSI-RS resource index #6, and SRS resource #3 is on.

In addition, the signaling can indicate whether the spatial domain filter associated with the first set of RS is on or off in various manners. For example, the first signaling may indicate whether the spatial domain filter associated with the first set of RS is on or off by a bitmap corresponding to each RS of the first set of RS. For example, “1” means on, and “0” means off in the bitmap. For a signaling in pattern, multiple bitmaps will be used to indicate the pattern.

In some other embodiments of the present application, the signaling may indicate whether the first spatial domain filter associated with the first set of RS is on or off by codepoints. Each codepoint indicates a group containing at least one RS associated with a spatial domain filter being on (i.e., a group only including RS associated with a spatial domain filter being on) or a group containing at least one RS associated with a spatial domain filter being off (i.e., a group only including RS associated with a spatial domain filter being off). For a RS, whether the RS is within the group containing at least one RS associated with a spatial domain filter being on, or within the group containing at least one RS associated with a spatial domain filter being off is predefined or configured by a higher layer signaling, e.g., RRC or MAC CE. In other words, the at least one RS within a group can be predefined or configured by higher layer signaling. For example, a group contains at least one of: SSB, CSI-RS, and SRS. SSB and/or CSI-RS and/or SRS may be indicated within one group by RRC with a group index, wherein SSB index and/or CSI-RS resource index and/or SRS resource index associated with a spatial domain filter which is considered to be on, are indicated by a group index, and others associated with another spatial domain filter which is considered to be off, are not indicated by the group index or indicated by another group index. Group common DCI can be used to indicate one of the groups. Alternatively, a group can be configured with at least one of: SSB resource, CSI-RS resource, SRS resource by the resource index; and when the group index is indicated by a beam status indication signaling (i.e., the first signaling), the spatial domain filter associated with all RS within the group will be considered to be on. For a signaling in pattern, sequence of group indexes will be used to indicate the pattern.

To obviate the great impact on various physical layer procedures associated with the beam being dynamically indicated on or off, the network side and the remote side need to adopt proper measures based on the signaling according to some embodiments of the present application. For example, in the network side, a second set of RS is determined (or maintained or updated etc.) in step 203 based on the signaling; and similarly, in the remote side, a second set of RS is determined in step 204 based on the signaling. At least one of the second set of RS may be the same or different from the first set of RS, while at least one RS of the second set of RS is directly or indirectly associated with the spatial domain filter dynamically indicated on or off in the signaling.

According to some embodiments of the present application, the second set of RS may be a set of RS associated with CSI reporting, or a set of pathloss RS, or a set of RS associated with RLM, or a set of RS associated with BFR. Persons skilled in the art should well know that although only one second set RS to be determined (or maintained or updated) based on the signaling is illustrated, one or more such set of RS can be respectively determined based on the signaling considering various physical layer procedures associated with the spatial domain filter dynamically indicated on or off. For example, a set of RS associated with CSI reporting and a set of pathloss RS may be respectively determined due to at least one RS of the set of RS associated with CSI reporting and at least one RS of the set of pathloss RS being associated with the spatial domain filter dynamically indicated on or off.

More details on how to determine or maintain the second set of RS will be illustrated below in view of different physical procedures. In addition, herein, for simplification and clearness, “a spatial domain filter (or beam) indicated on or off” always means that such an indication is applied in the UE side and/or network side.

### Impact on CSI Reporting

The application of dynamic beam on/off indication mechanism may affect CSI reporting, which involves CSI resource reception, CSI measurement, and CSI reporting metric, etc. A set of RS associated with CSI reporting will be determined or maintained under the dynamic beam on/off indication mechanism.

For example, in some embodiments of the present application, the second set of RS is a set of RS to be received for CSI measurement. For example, the second set of RS is a set of CSI-RS, or a set of SSB, or a set of CSI-RS and SSB to be transmitted in the network side and to be received in the remote side. If the spatial domain filter associated with at least one RS of the second set of RS is off, the at least one RS will be excluded from the second set of RS. That is, the network side, e.g., gNB will not transmit the at least one RS associated with the beam indicated off; and the remote side, e.g., UE will not receive the at least one RS associated with the beam indicated off.

In some embodiments of the present application, the second set of RS is a set of RS to be measured. For example, the second set of RS is a set of CSI-RS, or a set of SSB, or a set of CSI-RS and SSB to be measured in the remote side. If the spatial domain filter associated with at least one RS of the second set of RS is off, then, the at least one RS will be excluded from the second set of RS. That is, even if being received in the remote side, UE will not measure CSI based on the at least one RS associated with the beam indicated off. Accordingly, the network side will not receive the CSI measured based on the at least one RS.

CSI measurement may be averaged in some embodiments of the present application. The second set of RS may be a set of RS where CSI measurement will be averaged. If the spatial domain filter associated with at least one RS of the second set of RS is off, the at least one RS will be excluded from the second set of RS. That is, CSI measured based on the at least one RS will not be used for averaging. For example, CSI-RS #1 is configured to be transmitted in time instance #1, time instance #3, time instance #5, time instance #7, time instance #9, time instance #11, and time instance #13, which is in total 7 times. If the spatial domain filter associated with CSI-RS #1 indicated off is applied after time instance #6, then only measurement result on time instance #1, time instance #3, and time instance #5 will be averaged, and the measurement results on time instance #7, time instance #9, time instance #11, and time instance #13 will not be used to calculate the average value.

In another embodiment of the present application, averaging CSI measurement on the second set of RS before application of the signaling and averaging CSI measurement on the second set of RS after the application of the signaling are separate. That is, the CSI measurement on the second set of RS before application of the signaling will be averaged, and the CSI measurement on the second set of RS after the application of the signaling will be averaged.

According to some other embodiments of the present application, another signaling may further indicate the beam associated with the at least one RS on again. Then, averaging CSI measurement on the second set of RS before application of the previous signaling indicating the beam off and averaging CSI measurement on the second set of RS after the application of the other signaling indicating the beam on are separately performed. For example, CSI-RS #1 is configured to be transmitted in time instance #1, time instance #3, time instance #5, time instance #7, time instance #9, time instance #11, and time instance #13, which is in total 7 times. If the spatial domain filter associated with CSI-RS #1 indicated off is applied after time instance #6 and the spatial domain filter associated CSI-RS #1 indicated on is applied after time instance #10, then a first average value will be determined based on CSI measurement on time instance #1, time instance #3, and time instance #5, and a second average value will be determined based on CSI measurement on time instance #11 and time instance #13. These two average values will be calculated separately.

In some embodiments of the present application, CSI reporting metric may be affected by the dynamic beam on/off indication. The second set of RS may be a set of RS associated with CSI reporting where at least one resource index will be reported (i.e., CSI resource index reporting or SSB index reporting). The second set of RS may also be a set of RS, and at least one CSI reporting metric is based on the set of RS. The CSI reporting metric may be precoding matrix indicator (PMI) reporting, rank indicator (RI) reporting, channel quality indicator (CQI) reporting, or layer indicator (LI) reporting, etc.

For CSI resource index reporting (CSI-RS resource index or SSB index), a set of RS index for CSI reporting will be reported. For example, in the case of group reporting disabled, a single RS index will be reported or multiple RS indexes will be reported, and in the case of group reporting enabled, a pair of RS indexes will be reported or multiple pairs of RS indexes will be reported. If the spatial domain filter associated with at least one RS of the second set of RS is off, the at least one RS index will be excluded from the set of RS index for CSI reporting according to some embodiments of the present application. That is, the at least one RS index associated with the beam indicated off will not be selected as a CSI resource index or a CSI resource index of a pair of indexes for CSI reporting in the remote side, and the second set of RS will not change. For example, CSI-RS #1, CSI-RS #2, CSI-RS #3, CSI-RS #4, and CSI-RS #5 are configured for L1-reference signal received power (RSRP) reporting, and the number of RS to be reported is 2. CSI-RS #2 has the largest L1-RSRP, and CSI-RS #4 has the second largest L1-RSRP, CSI-RS #5 has third largest L1-RSRP. CSI-RS #4 is indicated off based on the signaling. Before the application of the signaling, CSI-RS resource indexes #2 and #4 will be reported. After the application of the signaling, CSI-RS resource indexes #2 and #5 will be reported.

According to some other embodiments of the present application, the at least one RS will be excluded from the second set of RS, and accordingly the second set of RS will change. That is, the second set of RS will not include the at least one RS anymore. In any case, the network side will not receive the at least one RS index associated with the beam indicated off. For example, CSI-RS #1, CSI-RS #2, CSI-RS #3, CSI-RS #4, and CSI-RS #5 are configured for L1-RSRP reporting, and the number of RS to be reported is 2. CSI-RS #2 has the largest L1-RSRP, and CSI-RS #4 has the second largest L1-RSRP, CSI-RS #5 has third largest L1-RSRP. CSI-RS #4 is indicated off based on the signaling. Before the application of the signaling, the CSI-RS resource set for reporting including CSI-RS #2, CSI-RS #3, CSI-RS #4, and CSI-RS #5, and their corresponding index within the set is #1, #2, #3, #4, and #5 respectively. After the application of the signaling, the CSI-RS resource set for reporting including CSI-RS #1, SI-RS #2, CSI-RS #3, and CSI-RS #5, and their corresponding index within the set is #1, #2, #3 and #4 respectively. Then for the reporting before the application of the signaling, indexes #2 and #4 will be reported, which is corresponding to CSI-RS #2 and CSI-RS #4, respectively. After the application of the signaling, although indexes #2 and #4 will be reported, they correspond to CSI-RS #2 and CSI-RS #5, respectively.

In the case that the second set of RS is a set of RS where CSI will be based on a CSI resource, e.g., PMI, RI, etc., and the spatial domain filter associated with the CSI resource is off, UE will stop reporting the CSI or report the CSI with a reserved or predefined value. Accordingly, the network side will stop receiving the CSI or receive the CSI with a reserved or predefined value.

### Impact on Power Control

In some scenarios, dynamic beam on/off indication may affect power control of PUSCH, power control of PUCCH, power control of SRS, or affect power headroom reporting (PHR), etc.

For example, UE may maintain a number of RS, i.e., the second set of RS to calculate the pathloss. The second set of RS may be a set of pathloss RS for power control of at least one of PUSCH, PUCCH or SRS or may be a set of pathloss RS for PHR. A pathloss RS identity or index (ID) may be indicated by signal resource indicator (SRI), or determined to be ID=0. Taking PUSCH as an example, TS38.213 specifies that:
If
   the PUSCH transmission is scheduled by DCI format 0_0 and the UE is not provided a spatial setting for a PUCCH transmission, or
   the PUSCH transmission is scheduled by DCI format 0_1 or DCI format 0_2 that does not include an SRI field, or
   SRI-PUSCH-PowerControl is not provided to the UE, the UE determines a RS resource index q_{d} with a respective PUSCH-PathlossReferenceRS-Id value being equal to zero where the RS resource is either on serving cell c or, if provided, on a serving cell indicated by a value of pathlossReferenceLinking

The second set of RS will be maintained (or updated) based on the dynamic beam on/off indication. If the spatial domain filter associated with at least one RS of the second set of RS is indicated off, the at least one RS will be excluded from the second set of RS. That is, the second set of RS will not include the at least one RS. If the spatial domain filter associated with at least one RS of the second set of RS is indicated on, the at least one RS will be added to the second set of RS in the case of a total number of the second set of RS being less than a configured or predefined number, e.g., 4. If the total number of RS within the second set of RS reaches the configured or predefined number, no RS will be added even if its associated beam indicated on. Thus, the at least one RS associated with a beam indicated on is added to the set of RS set in an order, e.g., in an ascending order of RS index, i.e., from the lowest indexed RS of the at least one RS until reaching the configured or predefined number. The network side will maintain such a set of pathloss RS similarly.

In some embodiments of the present application, the second set of RS is a pathloss RS for power control of at least one of PUSCH, PUCCH or SRS or for PHR, and the pathloss RS can be determined based on various manners, e.g., determined based on a lowest indexed PUCCH resource of a set of PUCCH resource. Taking PHR reporting as an example, TS38.213 specifies that:
If the UE determines that a Type 1 power headroom report for an activated serving cell is based on a reference PUSCH transmission then, for PUSCH transmission occasion i on active UL BWP b of carrier f of serving cell C, the UE computes the Type 1 power headroom report as

$$P {H}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

where \tilde{P}_{CMAX,f,c}(i) is computed assuming MPR=0 dB, A-MPR=0 dB, P-MPR=0 dB. □Tc=0 dB. MPR, A-MPR, P-MPR and DTc are defined in [4-1, TS 38.101-1], [4-2, TS38.101-2] and [4-3, TS 38.101-3]. The remaining parameters are defined in Clause 3.1.1 where P_{O_PUSCH,b,f,c}(j) and α_{b,f,c}(j) are obtained using P_{O_NOMINAL_PUSCH,f,c}(0) and p0-PUSCH-AlphaSetId=0, PL_{b,f,c}(q) is obtained using pusch-PathlossReferenceRS-Id=0, and l=0.

The second set of RS, e.g., the pathloss RS for PHR, will be maintained or updated by updating the set of PUCCH resource based on the dynamic beam on/off indication in the network side and remote side. If the spatial domain filter associated with at least one RS of the set of PUCCH resource is off, the at least one RS will be excluded from the set of PUCCH resource. Accordingly, the second set of pathloss RS, e.g., the pathloss RS for PHR will not be determined based on the excluded PUCCH resource. Alternatively, the PUCCH resource set may be kept the same, while the lowest indexed PUCCH resource for determining the pathloss RS is determined to be the lowest indexed PUCCH resource whose associated spatial domain filter is indicated on.

In some embodiments of the present application, the second set of RS is a RS associated with (or for) power control of at least one of PUSCH, PUCCH or SRS or associated with PHR, and the pathloss RS is determined based on a lowest indexed CORESET of a set of CORESET. Taking PUSCH as an example, TS38.213 specifies that:
If the PUSCH transmission is scheduled by DCI format 0_0, and if the UE is provided a spatial setting by PUCCH-SpatialRelationInfo for a PUCCH resource with a lowest index for active UL BWP b of each carrier f and serving cell c, as described in Clause 9.2.2, the UE uses the same RS resource index q_{d} as for a PUCCH transmission in the PUCCH resource with the lowest index
If
   the PUSCH transmission is scheduled by DCI format 0_0 on serving cell c,
   the UE is not provided PUCCH resources for the active UL BWP of serving cell c, and
   the UE is provided enableDefaultBeamPL-ForPUSCH0-0
the UE determines a RS resource index q_{d} providing a periodic RS resource configured with qcl-Type set to ‘typeD’ in the TCI state or the QCL assumption of a CORESET with the lowest index in the active DL BWP of the serving cell c

The second set of RS, e.g., the pathloss RS for PUSCH, will be maintained (or updated) by updating the set of CORESET based on the dynamic beam on/off indication in the network side and remote side. If the spatial domain filter associated with at least one CORESET of the set of CORESET is off, the at least one CORESET will be excluded from the set of CORESET. Accordingly, the second set of pathloss RS, e.g., the pathloss RS for power control of PUSCH will not be determined based on the excluded CORESET. Alternatively, the CORESET set may be kept the same, while the lowest indexed CORESET for determining the pathloss RS is determined to be the lowest indexed CORESET whose associated spatial domain filter is indicated on.

In some embodiments of the present application, the second set of RS is a pathloss RS for power control of at least one of PUSCH, PUCCH or SRS or for power headroom reporting, and the pathloss RS is based on a PDSCH transmission TCI state with lowest index of a set of PDSCH TCI state.

Taking PUCCH as an example, TS38.213 specifies that:
If the UE is provided pathlossReferenceRSs and is not provided PUCCH-SpatialRelationInfo, the UE obtains the referenceSignal value in PUCCH-PathlossReferenceRSfrom the pucch-PathlossReferenceRS-Id with index 0 in PUCCH-PathlossReferenceRS where the RS resource is either on the primary cell or, if provided, on a serving cell indicated by a value of pathlossReferenceLinking
If the UE
   is not provided pathlossReferenceRSs, and
   is not provided PUCCH-SpatialRelationInfo, and
   is provided enableDefaultBeamPL-ForPUCCH, and
   is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212] the UE determines a RS resource index q_{d} providing a periodic RS resource configured with qcl-Type set to ‘typeD’ in the TCI state or the QCL assumption of a CORESET with the lowest index in the active DL BWP of the primary cell. For a PUCCH transmission over multiple slots, a same q_{d} applies to the PUCCH transmission in each of the multiple slots.

In addition, taking SRS as an example, TS38.213 specifies that:
If the UE
   is not provided pathlossReferenceRS or SRS-PathlossReferenceRS-Id,
   is not provided spatialRelationInfo, and
   is provided enableDefaultBeamPL-ForSRS, and
   is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212]
the UE determines a RS resource index q_{d} providing a periodic RS resource configured with qcl-Type set to ‘typeD’ in
   the TCI state or the QCL assumption of a CORESET with the lowest index in the active DL BWP, if CORESETs are provided in the active DL BWP of serving cell c
   the active PDSCH TCI state with lowest ID [6, TS 38.214] in the active DL BWP, if CORESETs are not provided in the active DL BWP of serving cell c

The second set of RS, e.g., the pathloss RS for power control of PUSCH or SRS, will be maintained or updated by maintaining the set of PDSCH TCI state based on the dynamic beam on/off indication in the network side and remote side. If the spatial domain filter associated with at least one RS associated with at least one PDSCH TCI state of the set of PDSCH TCI state is off, the at least one PDSCH TCI state will be excluded from the set of PDSCH TCI state. Accordingly, the second set of pathloss RS, e.g., the pathloss RS for power control for PUSCH or for SRS will not be determined based on the excluded PDSCH TCI state. Alternatively, the PDSCH TCI state list may be kept the same, while the lowest indexed PDSCH TCI state for determining the pathloss RS is determined to be the lowest indexed PDSCH TCI state whose associated spatial domain filter is indicated on.

In addition, although TS38.213 is used to illustrate the one or more pathloss RSs for power control of at least one of PUSCH, PUCCH or SRS or for power headroom reporting etc., persons skilled in the art should well know that as the evolution of 3GPP, these determination manners or association may change, and the determination manners or association should not be limited to these illustrated manners.

### Impact on RLM

Dynamic beam on/off indication may also affect radio link monitoring, and the set of RS associated with RLM, which may be directly or indirectly indicated to the UE, will be updated (or maintained, or determined) based on the dynamic beam on/off indication in the network side and remote side.

For example, as specified in TS38.213, in some embodiments of the present application, a set of RLM RS is indicated to the UE.
The physical layer in the UE indicates, in frames where the radio link quality is assessed, out-of-sync to higher layers when the radio link quality is worse than the threshold Qₒᵤₜ for all resources in the set of resources for radio link monitoring. When the radio link quality is better than the threshold Qᵢₙ for any resource in the set of resources for radio link monitoring, the physical layer in the UE indicates, in frames where the radio link quality is assessed, in-sync to higher layers.

In this case the second set of RS is a set of RLM RS indicated by a higher layer signaling. If the spatial domain filter associated with at least one RS of the second set of RS is off, the at least one RS will be excluded from the second set of RS. That is, the at least one RS will not be used for RLM. If the spatial domain filter associated with at least one RS of the second set of RS is on, the at least one RS will be added to the second set of RS. That is, the at least one RS may be used for RLM. The addition of the at least one RS can be in an ascending order of RS index, i.e., from the lowest indexed RS of the at least one RS (in an increasing number of RS index) indicated on until the total number of RLM RS reaches a predefined or configured number, e.g. 4.

When the UE is not provided RLM RS by higher layer signaling, the RLM RS may be implicitly determined by the quasi co-location (QCL)-typeD RS of a selected CORESET. In this case, the second set of RS is a RLM RS determined based on a CORESET of a set of CORESET. For example, according to TS38.213, the selected CORESET is determined based on CORESET periodicity and CORSET ID as following:
If the UE is not provided RadioLinkMonitoringRS and the UE is provided for PDCCH receptions TCI states that include one or more of a CSI-RS
   the UE uses for radio link monitoring the RS provided for the active TCI state for PDCCH reception if the active TCI state for PDCCH reception includes only one RS
   if the active TCI state for PDCCH reception includes two RS, the UE expects that one RS is configured with qcl-Type set to ‘typeD’ [6, TS 38.214] and the UE uses the RS configured with qcl-Type set to ‘typeD’ for radio link monitoring; the UE does not expect both RS to be configured with qcl-Type set to ‘typeD’
   the UE is not required to use for radio link monitoring an aperiodic or semi-persistent RS
   For Lₘₐₓ=4, the UE selects the N_{RLM} RS provided for active TCI states for PDCCH receptions in CORESETs associated with the search space sets in an order from the shortest monitoring periodicity. If more than one CORESETs are associated with search space sets having same monitoring periodicity, the UE determines the order of the CORESET from the highest CORESET index as described in Clause 10.1.

The second set of RS will be maintained or updated by updating the set of CORESET based on the dynamic beam on/off indication in the network side and remote side. In the case that the spatial domain filter associated with at least one RS associated with at least one CORESET of the set of CORESET is off, the at least one CORESET will be excluded from the set of CORESET. Accordingly, the RLM RS will not be determined based on the excluded at least one CORESET. In the case that the spatial domain filter associated with at least one RS associated with at least one CORESET of the set of CORESET is on, the at least one CORESET will be added to the set of CORESET. Accordingly, the RLM RS may be determined based on the added at least one CORESET. Alternatively, the CORESET for determining the RLM RS may be only based on whose associated spatial domain filter is indicated on.

### Impact on BFR

Dynamic beam on/off indication may also affect beam failure recovery, which involves candidate beam RS set maintenance and failure detection resource set maintenance. Accordingly, the second set of RS is a set of RS associated with BFR, which may be a set of candidate beam RS or a set of failure detection resource.

For example, a set of candidate beam RS is configured for BFR by high layer signaling according to TS 38.213:
A UE can be provided, for each BWP of a serving cell, a set q̅₀̅ of periodic CSI-RS resource configuration indexes by failureDetectionResources and a set q̅₁̅ of periodic CSI-RS resource configuration indexes and/or SS/PBCH block indexes by candidateBeamRSList or candidateBeamRSListExt or candidateBeamRSSCellList for radio link quality measurements on the BWP of the serving cell.
   In addition, the UE will provide L1-RSRP to high layer(s) based on the measurement result of the candidate RS list, e.g., according to TS 38.213:
For the PCell or the PSCell, upon request from higher layers, the UE provides to higher layers the periodic CSI-RS configuration indexes and/or SS/PBCH block indexes from the set q̅₁̅ and the corresponding L1-RSRP measurements that are larger than or equal to the Q_{in,LR} threshold.
For the SCell, upon request from higher layers, the UE indicates to higher layers whether there is at least one periodic CSI-RS configuration index and/or SS/PBCH block index from the set q̅₁̅ with corresponding L1-RSRP measurements that are larger than or equal to the Q_{in,LR} threshold, and provides the periodic CSI-RS configuration indexes and/or SS/PBCH block indexes from the set q̅₁̅ and the corresponding L1-RSRP measurements that are larger than or equal to the Q_{in,LR} threshold, if any.

The second set of RS will be maintained or updated based on the dynamic beam on/off indication in the network side and remote side. For example, if the spatial domain filter associated with at least one RS of the second set of RS is off, the at least one RS will be excluded from the second set of RS. That is, in the case of the second set of RS being a set of candidate beam RS, the excluded at least one RS is not a candidate beam RS; and in the case of the second set of RS being a set of failure detection resource, the at least one RS is not a failure detection resource. Alternatively, if the spatial domain filter associated with at least one RS of the second set of RS is on, the at least one RS will be added to the second set of RS. That is, in the case of the second set of RS being a set of candidate beam RS, the at least one RS is added to the candidate beam RS list until the total number of candidate RS reaches a predefined or configured number; and in the case of the second set of RS being a set of failure detection resource, the at least one RS is added to the set of failure detection resource until the number of failure detection resources reaches a predefined or configured number.

Besides the methods, embodiments of the present application also propose a wireless communication apparatus.

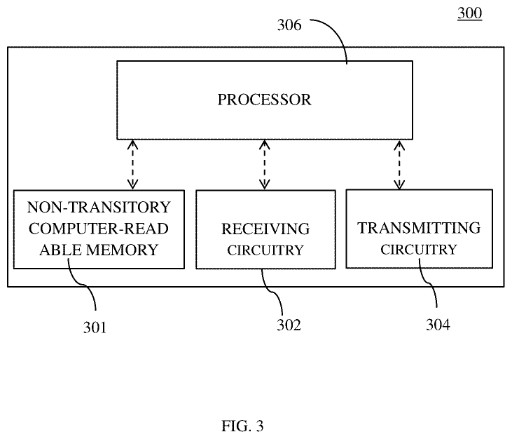

For example, FIG. 3 illustrates a block diagram of a wireless communication apparatus 300 according to some embodiments of the present application.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The at least one processor 306 may be a CPU, a DSP, a microprocessor etc. The apparatus 300 may be a network apparatus, e.g., a gNB or a remote apparatus, e.g., UE configured to perform a method illustrated in the above or the like.

Although in this figure, elements such as the at least one processor 306, transmitting circuitry 304, and receiving circuitry 302 are described in the singular, the plural is contemplated unless a limitation to the singular is explicitly stated. In some embodiments of the present application, the receiving circuitry 302 and the transmitting circuitry 304 can be combined into a single device, such as a transceiver. In certain embodiments of the present application, the apparatus 300 may further include an input device, a memory, and/or other components.

In some embodiments of the present application, the non-transitory computer-readable medium 301 may have stored thereon computer-executable instructions to cause a processor to implement the method with respect to the network apparatus as described above. For example, the computer-executable instructions, when executed, cause the processor 306 interacting with receiving circuitry 302 and transmitting circuitry 304, so as to perform the steps with respect to the network apparatus as depicted above.

In some embodiments of the present application, the non-transitory computer-readable medium 301 may have stored thereon computer-executable instructions to cause a processor to implement the method with respect to the UE as described above. For example, the computer-executable instructions, when executed, cause the processor 306 interacting with receiving circuitry 302 and transmitting circuitry 304, so as to perform the steps with respect to the UE as illustrated above.

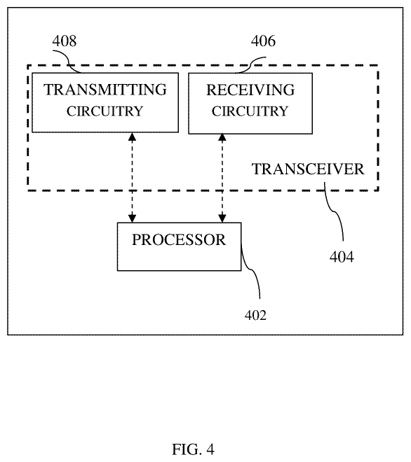

FIG. 4 is a block diagram of a wireless communication apparatus according to some other embodiments of the present application.

Referring to FIG. 4, the apparatus 400, for example a gNB or a UE may include at least one processor 402 and at least one transceiver 404 coupled to the at least one processor 402. The transceiver 404 may include at least one separate receiving circuitry 406 and transmitting circuitry 404, or at least one integrated receiving circuitry 406 and transmitting circuitry 404. The at least one processor 402 may be a CPU, a DSP, a microprocessor etc.

According to some embodiments of the present application, when the apparatus 400 is a remote apparatus, the processor is configured to: receive a signaling indicating a first set of RS, wherein a spatial domain filter associated with the first set of RS is on or off; and determine a second set of RS based on the signaling, wherein the second set of RS is a set of RS associated with CSI reporting, or a set of pathloss RS, or a set of RS associated with RLM, or a set of RS associated with BFR.

According to some other embodiments of the present application, when the apparatus 400 is a network apparatus, the processor may be configured to: transmit a signaling indicating a first set of RS, wherein a spatial domain filter associated with the first set of RS is on or off; and determine a second set of RS based on the signaling, wherein the second set of RS is a set of RS associated with CSI reporting, or a set of pathloss RS, or a set of RS associated with RLM, or a set of RS associated with BFR.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, the UE comprising:
at least one memory;
at least one receiving circuitry;
at least one transmitting circuitry; and
at least one processor coupled to the memory, the at least one receiving circuitry, and the at least one transmitting circuitry, wherein the at least one processor is configured to cause the UE to:
receive, via the at least one receiving circuitry, a signaling indicating a first set of reference signal (RS), wherein a spatial domain filter associated with the first set of RS is on or off; and
determine a second set of RS based on the signaling, wherein the second set of RS comprises one of a set of RS associated with channel state information (CSI) reporting, or a set of pathloss RS, or a set of RS associated with radio link monitoring (RLM), or a set of RS associated with beam failure recovery (BFR).

2. The UE according to claim 1, wherein;
the second set of RS is a set of RS associated with CSI reporting to be measured, and the spatial domain filter associated with at least one RS of the second set of RS is off; and
the at least one processor is configured to cause the UE to exclude the at least one RS from the second set of RS.

3. The UE according to claim 1, wherein:
the second set of RS is a set of RS associated with CSI reporting where CSI measurement will be averaged, and the spatial domain filter associated with at least one RS of the second set of RS is off; and
the at least one processor is configured to cause the UE to exclude the at least one RS from the second set of RS.

4. The UE according to claim 1, wherein:
the second set of RS is a set of RS associated with CSI reporting where at least one resource index will be reported, and the spatial domain filter associated with at least one RS of the second set of RS is off; and
the at least one processor is configured to cause the UE to:
exclude the at least one RS index from a set of RS index for CSI reporting; or
exclude the at least one RS from the second set of RS.

5. The UE according to claim 1, wherein:
the second set of RS is a set of RS associated with CSI reporting where CSI will be based on a CSI resource, and the spatial domain filter associated with the CSI resource is off; and
the at least one processor is configured to cause the UE to perform one of:
stop reporting the CSI; or
report the CSI with a reserved or predefined value.

6. The UE according to claim 1, wherein:
the second set of RS is a set of pathloss RS for power control of at least one of physical uplink shared channel (PUSCH), physical uplink control channel (PUCCH), or sounding reference signal (SRS) or for power headroom reporting;
the spatial domain filter associated with at least one RS of the second set of RS is off; and
the at least one processor is configured to cause the UE to exclude the at least one RS from the second set of RS.

7. The UE according to claim 1, wherein:
the second set of RS is a set of pathloss RS for power control of at least one of physical uplink shared channel (PUSCH), physical uplink control channel (PUCCH), or sounding reference signal (SRS) or for power headroom reporting;
the spatial domain filter associated with at least one RS of the second set of RS is on; and
the at least one processor is configured to cause the UE to add the at least one RS to the second set of RS in response to a total number of the second set of RS being less than a configured or predefined number.

8. The UE according to claim 1, wherein;
the second set of RS is a pathloss RS for power control of at least one of physical uplink shared channel (PUSCH), physical uplink control channel (PUCCH), or sounding reference signal (SRS) or for power headroom reporting, the pathloss RS being determined based on a lowest indexed PUCCH resource of a set of PUCCH resource;
the spatial domain filter associated with at least one RS of the set of PUCCH resource is off; and
the at least one processor is configured to cause the UE to exclude the at least one RS from the set of PUCCH resource.

9. The UE according to claim 1, wherein:
the second set of RS is a RS associated with power control of at least one of physical uplink shared channel (PUSCH), physical uplink control channel (PUCCH), or sounding reference signal (SRS) or associated with power headroom reporting;
a pathloss RS is determined based on a lowest indexed control resource set (CORESET) of a set of CORESET;
the spatial domain filter associated with at least one CORESET of the set of CORESET is off; and
the at least one processor is configured to cause the UE to exclude the at least one CORESET from the set of CORESET.

10. The UE according to claim 1, wherein;
the second set of RS is a pathloss RS for power control of at least one of physical uplink shared channel (PUSCH), physical uplink control channel (PUCCH), or sounding reference signal (SRS) or for power headroom reporting, the pathloss RS being based on a physical downlink shared channel (PDSCH) transmission configuration indication (TCI) state with lowest index of a set of PDSCH TCI state;
the spatial domain filter associated with at least one RS associated with at least one PDSCH TCI state of the set of PDSCH TCI state is off; and
the at least one processor is configured to cause the UE to exclude the at least one PDSCH TCI state from the set of PDSCH TCI state.

11. The UE according to claim 1, wherein:
the second set of RS is one of a set of RLM RS or a set of RS associated with BFR;
the spatial domain filter associated with at least one RS of the second set of RS is off; and
the at least one processor is configured to cause the UE to exclude the at least one RS from the second set of RS.

12. The UE according to claim 1, wherein the second set of RS is a RLM RS determined based on a control resource set (CORESET) of a set of CORESET, and the spatial domain filter associated with at least one RS associated with at least one CORESET of the set of CORESET is off, the at least one processor is configured to:
exclude the at least one CORESET from the set of CORESET.

13. (canceled)

14. (canceled)

15. (canceled)

16. A processor for wireless communication, the processor comprising:
at least one of a central processing unit, a digital signal processor, and a microprocessor coupled with at least one memory and configured to:
receive, via at least one receiving circuitry, a signaling indicating a first set of reference signal (RS), wherein a spatial domain filter associated with the first set of RS is on or off; and
determine a second set of RS based on the signaling, wherein the second set of RS comprises one of a set of RS associated with channel state information (CSI) reporting, or a set of pathloss RS, or a set of RS associated with radio link monitoring (RLM), or a set of RS associated with beam failure recovery (BFR).

17. The processor of claim 16, wherein:
the second set of RS is a set of RS associated with one of (i) CSI reporting to be measured and (ii) CSI reporting where CSI measurement will be averaged;
the spatial domain filter associated with at least one RS of the second set of RS is off; and
the processor is further configured to exclude the at least one RS from the second set of RS.

18. The processor of claim 16, wherein:
the second set of RS is a set of RS associated with CSI reporting where at least one resource index will be reported;
the spatial domain filter associated with at least one RS of the second set of RS is off; and
the at least one processor is configured to:
exclude the at least one RS index from a set of RS index for CSI reporting; or
exclude the at least one RS from the second set of RS.

19. A method performed by a user equipment (UE), the method comprising:
receiving a signaling indicating a first set of reference signal (RS), wherein a spatial domain filter associated with the first set of RS is on or off; and
determining a second set of RS based on the signaling, wherein the second set of RS is a set of RS associated with channel state information (CSI) reporting, or a set of pathloss RS, or a set of RS associated with radio link monitoring (RLM), or a set of RS associated with beam failure recovery (BFR).

20. The method of claim 19, wherein:
the second set of RS is a set of RS associated with CSI reporting where at least one resource index will be reported;
the spatial domain filter associated with at least one RS of the second set of RS is off; and
the method comprises one of:
excluding the at least one RS index from a set of RS index for CSI reporting; or
excluding the at least one RS from the second set of RS.

21. A base station for wireless communication, the base station comprising:
at least one memory;
at least one receiving circuitry;
at least one transmitting circuitry; and
at least one processor coupled to the at least one memory, the at least one receiving circuitry, and the at least one transmitting circuitry, wherein the at least one processor is configured to cause the base station to:
transmit, via the at least one transmitting circuitry, a signaling indicating a first set of reference signal (RS), wherein a spatial domain filter associated with the first set of RS is on or off; and
determine a second set of RS based on the signaling, wherein the second set of RS is a set of RS associated with channel state information (CSI) reporting, or a set of pathloss RS, or a set of RS associated with radio link monitoring (RLM), or a set of RS associated with beam failure recovery (BFR).

22. The base station of claim 20, wherein:
the second set of RS is a set of RS associated with CSI reporting where CSI will be based on CSI resource, and the spatial domain filter associated with the CSI resource is off; and
the at least one processor is configured to cause the base station to:
stop receiving the CSI; or
receive the CSI with a reserved or predefined value.

23. The base station of claim 20, wherein:
the second set of RS is a set of RS associated with CSI reporting where CSI measurement will be averaged, and the spatial domain filter associated with at least one RS of the second set of RS is off; and
the at least one processor is configured to cause the base station to:
stop receiving the CSI; or
receive the CSI with a reserved or predefined value.
